(19) United States
(12) Patent Application Publication
(10) Pub. No.: US 2022/0040013 A1
(43) Pub. Date: Feb. 10, 2022

(54) Bariatric Lift Assist Device

(71) Applicants: Christina Salas, Albuquerque, NM (US); Justin T. Baca, Albuquerque, NM (US); David Isaac Grow, Albuquerque, NM (US)

(72) Inventors: Christina Salas, Albuquerque, NM (US); Justin T. Baca, Albuquerque, NM (US); David Isaac Grow, Albuquerque, NM (US)

(73) Assignee: UNM Rainforest Innovations, Albuquerque, NM (US)

(21) Appl. No.: 17/421,002

(22) PCT Filed: Jan. 6, 2020
(86) PCT No.: PCT/US2020/012399

§ 371 Date: Jul. 6, 2021

Related U.S. Application Data
(60) Provisional application No. 62/788,574, filed on Jan. 4, 2019.

(51) Int. Cl. A61G 1/003; A61G 1/007

(52) U.S. Cl. CPC A61G 1/003; A61G 1/007

(57) ABSTRACT

A patient lifting apparatus designed to facilitate the lifting patients off the ground having a backboard having a perimeter, a patient receiving surface and an opposingly located lower surface having opposingly located bases thereon, each of the bases having opposingly located curved sections and a flat middle section located in between the curved sections.

### RELATED APPLICATIONS

This application is a U.S. 371 National Phase application of PCT/US2020/012399 filed on Jan. 6, 2020, which claims priority to U.S. Provisional Application Ser. No. 62/788,574 filed on Jan. 4, 2019, both of which are incorporated herewith in their entirety.

### BACKGROUND OF THE INVENTION

Emergency Medical Services (EMS) is defined as a service that is provided when an individual deems their medical condition an emergency and requires acute care and transport to a definitive care facility. EMS training and protocols emphasize proper body mechanics and lifting techniques to limit injuries, however, due to the force needed to transfer some patients, EMS personnel are frequently injured in the field when lifting a patient. One out of every four EMS personnel will suffer a career-ending back injury within the first four years of service due to lifting patients and 47% of EMS personnel will have injured their back while transporting patients during their career. These injuries occur while lifting the patient from the ground to the stretcher, bringing the stretcher to waist height, loading the stretcher into the ambulance, unloading the stretcher from the ambulance, and transferring the patient from the stretcher to the definitive care facility bed. According to the National Association of Emergency Medical Technicians (NAEMT), transportation of a patient accounts for 62% of injuries and back strain accounts for 78% of lost productivity and paid compensation. As of 2015, the national average weight is 195 lbs for men and 166 lbs for women. These weights alone are already more than what a team of two Emergency Medical Technicians (EMT) should be lifting.

The branch of medicine that deals with the causes, prevention, and treatment of obesity is known as bariatric medicine. Currently, Americans have the highest rates of obesity of any developed country in the world, and the alarming growths have taken a mere 10 years to progress. Due to this, EMS agencies are transporting an increasing number of bariatric patients and are required to follow certain safety protocols. Standard EMS transports require a two-person crew to avoid EMS personnel and patient injury but when a patient weighs greater than 300 pounds a minimum of four EMS workers are needed to assist in the lifting and for every additional ˜75 pounds another individual must be used in the lifting procedure. When an EMS system requires additional personnel to aid in the movement of a patient it decreases overall system efficiency. Many states also require an EMS safety officer and/or fire department personnel to aid in the movement of the patient. There is also the need for special equipment (bariatric spinal boards, stretcher, vehicles) and specific training procedures for EMS personnel.

Currently Available Technologies

Several steps are involved in lifting a patient from the ground and loading them into an ambulance. Gurneys serve admirably in transportation to and loading into the ambulance, but the typical gurney can only be lowered to a height of approximately 14″. Thus, the focus here is the process of lifting a bariatric patient to the height of a lowered gurney and transferring them onto it. The floor-to-14″ lift places tremendous physical strain on EMS personnel and is the primary source for worker injury. While physical strength and proper body mechanics play a critical role in minimizing injury risk, it is clear that these are not sufficient to forestall injury.

Relevant technologies for lifting bariatric patients are described below. Some allow for spine stabilization, which is sometimes required, while others do not. Additional limitations of current commercial products include complexity, bulk, cost, and versatility.

Bariatric Ambulances with Bariatric Stretcher and Spinal Board

Specialized ambulances and accompanying equipment are available to accommodate a bariatric patient. The ambulance cab is wider and has either tracks or a motorized ramp, which makes loading a bariatric individual safer. Stretchers are also wider and often have some form of assistance for raising the cot (e.g. a battery-powered hydraulic lift). Typically, these stretchers can move between a low position of 13″ off the ground to a raised position of 40″. Likewise, bariatric spinal boards exist and are built to handle wider loads of up to ˜300 kg. Critically, these devices still require EMS or fire department personnel to use manual power to lift the patient from the ground to the stretcher.

Lift/Carry/Transfer Sheets

These devices provide additional lift points once a patient is attached. They can be used with or without a spinal board, which makes this device usable with an individual with a spinal injury. The ability to begin the lift with handles elevated from the ground is likely to be a significant asset. However, these devices are also somewhat bulky, require manual power, and typically more than two EMS personnel.

Carry/transfer sheets are typically used with patients that do not require spinal stabilization. There are multiple handles and require at a minimum of four personnel to lift a normal patient and a minimum of six personnel to lift a bariatric patient. These devices are easily stored and come in multiple different designs and are easily sanitized.

Binder Lift

A variety of systems are similar to the above except that only the patient's torso is involved. For instance, the Binder Lift is a device that straps directly to a patient's chest cavity. This device creates an area where straps are attached directly to the patient, which aids in easier lifting. Again, lifting is still manual, and this device cannot be used with an individual with a spinal injury and multiple personnel are needed with a bariatric patient.

EZ Lift Rescue System

The “EZ lift rescue system” is a spinal board that incorporates a retractable handle the purpose of which is to place the EMT or fire department personnel in a lifting position that reduces strain on the body. EMT and fire department personnel are taught to lift with their legs and their back straight similar to proper deadlift technique. This device does not force the workers to lift properly but only to start the lift in a higher position, so injury is still possible with improper form or not enough personnel.

The Spineboard

The Spineboard is a spinal board that is wedge-shaped and includes a conveyer belt on the board to ease putting a patient on a spinal board. Typically, when a patient needs spinal stabilization EMT/fire department personnel maintain spinal alignment while turning the patient on their side and sliding the board beneath them. While this system eliminates the need to turn the patient on their side, this system has limitations including size, weight, additional parts, assembly time and the need for manual labor to lift the board from the ground to lower stretcher height. As with other devices, but compounded here because of the mechanical complexity, there may be difficulty in sanitizing and cleaning the conveyor belt when needed.

Prolift LX Portable Lift

The Proliftis similar to systems like the Mighty Evacsystem designed for confined workspace rescue (Miller (Honeywell), Smithfield, R.I.). Unlike that system, the Proliftuses a battery-powered winch to lift the patient. The device requires at a minimum of two individuals to assemble and operate. The device can be used with or without a spinal board, which makes it ideal for spinal injury patients. The device is large and there is required assembly and time need for this device to be effective.

Indeed Lift

The Indeed Lift is a device that is similar to the chair lift, but this device has a hydraulic mechanism that aids in the lifting of a patient that is in a seated position. The Indeed Lift cannot be used with a patient that has a spinal injury. The device requires a minimum of two EMS personnel to move the patient to the correct seated position on the device. The device is relatively compact and can be used as a chair to move the patient or as a transfer device to a stretcher. Notwithstanding these advantages, this device does not allow for spine immobilization, requires manually bringing the patient into a seated position, and then transferring them onto the shelf. A minor concern is that the wheels are of small diameter, and especially for bariatric patients, this poses concerns for navigating small steps and trim common to indoor spaces, let alone irregularities that can be expected outside.

### BRIEF SUMMARY OF THE INVENTION

In one embodiment, the present invention provides new tools that can reduce the incidence of back injury in EMS personnel. While a variety of tools exist for lifting bariatric patients, they either only address a portion of the lift, do not allow for spine immobilization, or have other critical limitations.

Embodiments of the present invention address these gaps by providing a device that maintains stability, requires only two EMS personnel to operate, reduces injury risk, improves or has a minimal impact on task duration, and has compactness, durability and form-factor characteristics suited to the needs of EMS service workers.

In one embodiment, the present invention provides a patient lifting system that improves the ergonomics as well reduces the number of emergency medical personnel needed to recover and stabilize a patient in the field.

In other embodiments, the present invention provides a device that is designed to eliminate the risks associated with lifting a bariatric patient onto a stretcher by having the system lift the patient level with the stretcher.

In another embodiment, the present invention provides a system for lifting that aids EMS workers when moving bariatric patients in the field.

In yet other embodiments, the present invention provides a device that can elevate (˜14 inches) and secure a wide array of patients from the floor to the stretcher.

In still further embodiments, the present invention provides a device that only needs two EMS workers to operate which decreases the need for additional assistance (EMT personnel, fire department personal).

In still further embodiments, the present invention provides a lifting system that can function as a transportation device to prevent injury, increase efficiency, and create a compact instrument that is user-friendly and becomes an essential tool for EMS service workers.

In another embodiment, the present invention provides a patient lifting apparatus designed to facilitate lifting patients off the ground having a backboard having a perimeter, a patient receiving surface and an opposingly located lower surface having opposingly located bases thereon, each of the bases having opposingly located curved sections and a flat middle section located in between the curved sections.

In another embodiment of the present invention, each of the bases is comprised of a pair of spaced-apart rockers, each of the rockers having a curved section that transitions into a flat section, the pair of rockers are spaced apart to form the flat middle section of the base.

In another embodiment of the present invention, the backboard has a plurality openings around the perimeter.

In another embodiment of the present invention, the openings are rectangular openings.

In another embodiment of the present invention, the rockers include a rectangular post that fits within the rectangular openings and are locked in place thereby preventing the rectangular posts from rotating within the rectangular openings.

In another embodiment of the present invention, the rockers include a channel that runs internally and around the curved surface, the channel is adapted to receive a strap.

In another embodiment of the present invention, the strap binds the rockers to the backboard.

In another embodiment of the present invention, the apparatus is adapted to lift patients to 14″ off the ground.

In another embodiment of the present invention, a lifting mechanism is included to raise a patient upwardly.

In another embodiment of the present invention, the lifting mechanism is scissors assembly controlled by a battery-powered tool designed to facilitate the lifting of patients to 14″ off the ground.

In another embodiment of the present invention, the lifting mechanism is an inflatable bladder.

In another embodiment of the present invention, the lifting mechanism is a hydraulic lifting mechanism.

In another embodiment of the present invention, the lifting mechanism is a screw system.

In another embodiment of the present invention, the lifting mechanism is a pulley system.

In another embodiment of the present invention, a method is provided for lifting a patient off of a surface including the following steps: providing a backboard having a perimeter, a patient receiving surface and an opposingly located lower surface having opposingly located bases thereon, each of the bases having opposingly located curved sections and a flat middle section located in between the curved sections; positioning a portion of the perimeter in near proximity to the patient and an opposing portion of the perimeter away from the patient; raising the portion of the perimeter located away from the patient causing the portion of the perimeter near the patient to rotate downwardly toward the patient while the backboard is supported on the bases and rotates on the curved portion of the bases; positioning the patient against the backboard; and pushing downwardly on the perimeter causing the backboard to rotate on the curved edges to lift the patient upwardly until coming into an at-rest position on the flat middle sections of the bases. The method may also include lifting a patient off of a flat surface by placing a lifting mechanism under the backboard and using the lifting mechanism to lift the backboard upwardly.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1A illustrates a first embodiment of the present invention.

FIG. 1B illustrates a second embodiment of the present invention.

FIG. 1C is a top view of the second embodiment of the present invention with portions removed.

FIG. 1D is a side view of the second embodiment of the present invention.

FIG. 1E is a rear view of the second embodiment of the present invention.

FIG. 1F is another rear view of the second embodiment of the present invention.

FIG. 2A illustrates an embodiment of the present in a position to engage a patient to be lifted.

FIG. 2B illustrates an embodiment of the present in a position that is at rest on the flat edges of the bases with a patient raised above the ground.

FIG. 2C illustrates an embodiment of the present in which a patient has been raised by a lifting mechanism.

FIGS. 3A, 3B, 3C, 3D and 3E provide various views of a rocker that may be used with an embodiment of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

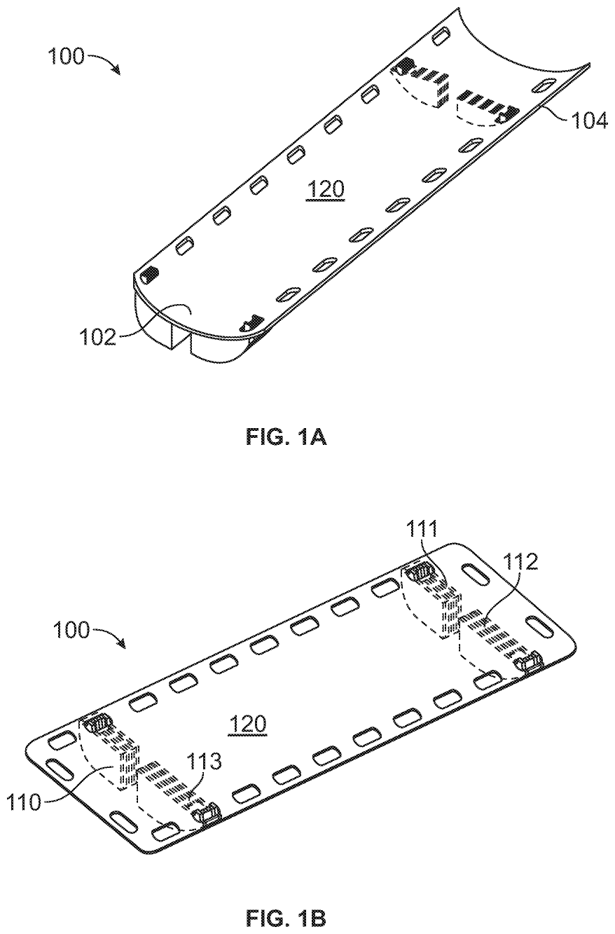

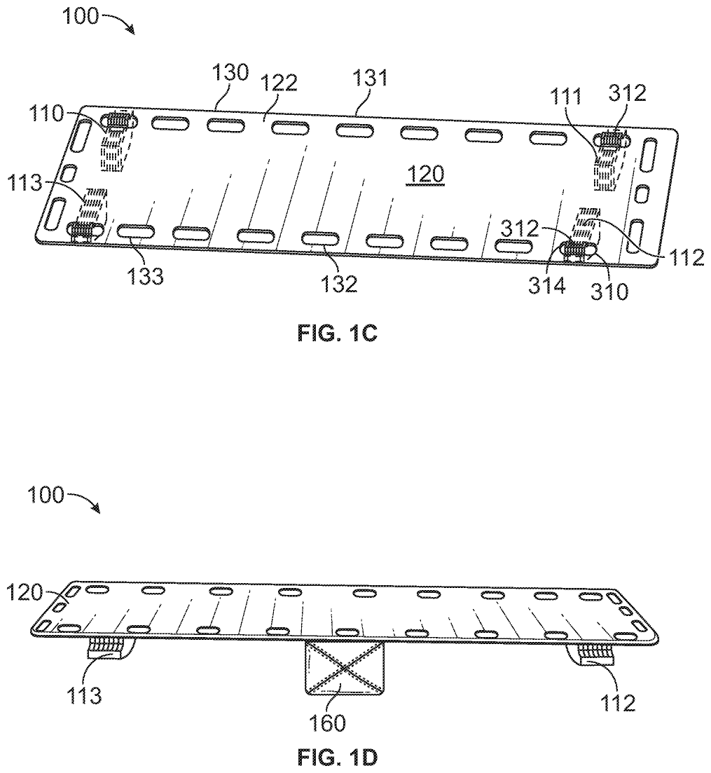

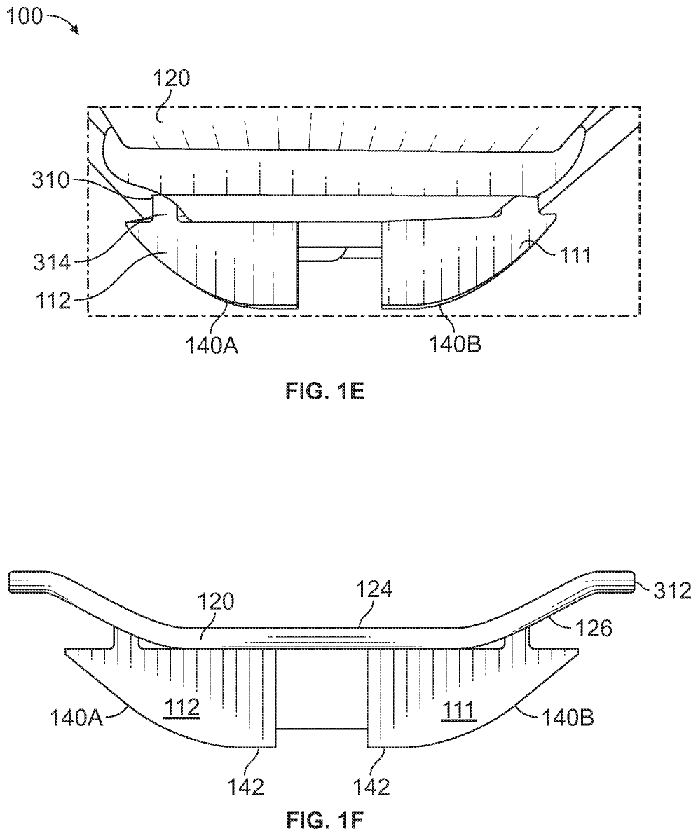

As shown below in FIG. 1A, in one embodiment the present invention provides a patient lifting system 100 which may be used as a bariatric lift system to improve the ergonomics as well minimize emergency medical personnel needed to recover and stabilize a patient in the field. System 100 includes a backboard 120 having an opposingly located first base 102 and second base 104.

In another embodiment, as shown in FIGS. 1A-1F, apparatus 100 includes backboard 120 having a perimeter 122, a patient receiving surface 124 and an opposingly located lower surface 126 having and opposingly located first base 102 and second base 104. The first and second bases having opposingly located curved sections 140A and 140B and a flat middle section 142 located in between curved sections 140A and 140B. The device is designed to eliminate or reduce personal risks associated with lifting a bariatric patient onto the stretcher by having the system lift the patient level with a stretcher using the curved and flat sections of the bases.

In a preferred embodiment, first base 102 and second base 104 are comprised of sections 110-113 that are in the form of rockers that may be releasably or permanently attached to backboard 120. As shown in FIGS. 1C-1D, backboard 120 may be rectangular and planar. As further shown in FIG. 1C, backboard 120 includes a plurality of rectangular openings 130-133 around perimeter 122 which function as handgrips. As shown, opening 130 is opposingly located from opening 133 and spaced apart from opening 131 which, in turn, is opposingly located from opening 132. The openings are also adapted to receive posts on rockers 110-113 which will be described below.

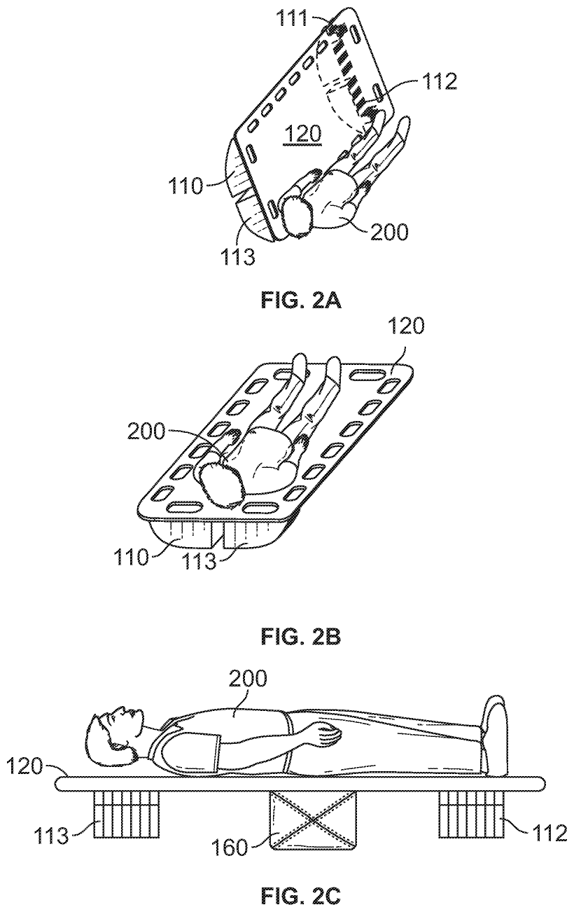

As shown in FIGS. 1E and 1F, rockers have curved edges 140A and 140B that terminate in a flat edge 142. As further shown rocker 111 is spaced apart from rocker 112 so as to align the flat edges 142 thereby allowing backboard 120 to rest in a stable position on a flat surface by creating a flat middle section. Rocker pairs 110 and 113 and rocker pairs 111 and 112 form bases under backboard 120 that support the backboard above a surface while allowing backboard 120 to be moved from a horizontal position to an angled position as shown in FIGS. 2A-2C.

In other embodiments, the present invention uses a mechanical lifting apparatus 160. In a preferred embodiment, the lifting apparatus is a mechanical (e.g. scissor) lift actuated by a battery-powered tool (e.g. hand drill) designed to facilitate the lifting of patients to 14″ off the ground. A carbon fiber backboard may be used as well to decrease weight and height of the backboard and to support spinal injuries for bariatric patients. Accordingly, this embodiment of the present invention is adapted to be operated by 2 people. In other embodiments, lifting apparatus 160 may include an inflatable bladder, hydraulic lifting mechanisms, screw systems, pulleys and in other ways known to those of skill in the art.

To transfer patient 200, the following methods may be used with the embodiments of the present invention. As shown in FIG. 2A, backboard 120 is positioned adjacent to patient 200 and rolled to one side using the curved surfaces on the rockers to hold the backboard stable on a surface. A patient 200 that is already rolled onto their side can now be captured by backboard 120 and rolled back flat to a resting height 3-6″ above the ground as shown in FIG. 2B. Lifting mechanism 160 is then deployed to raise patient 200 to a desired height as shown in FIG. 2C.

In a preferred method for lifting a patient off of a surface, a first step is to provide a backboard having a perimeter, a patient receiving surface and an opposingly located lower surface having opposingly located bases thereon, each of the bases having opposingly located curved sections and a flat middle section located in between said curved sections as described above. The next step is positioning a portion of the perimeter in near proximity to the patient and an opposing portion of the perimeter away from the patient. The next step is raising the portion of the perimeter located away from the patient causing the portion of the perimeter near the patient to rotate downwardly toward the patient while the backboard is supported on the bases and rotates on the curved portion of the bases. The next step is positioning the patient against the backboard. Lastly, the side of the perimeter that has been raised is pushed downwardly causing the backboard to rotate on the curved edges lifting a patient upwardly until coming into an at-rest position on the flat middle sections of said bases.

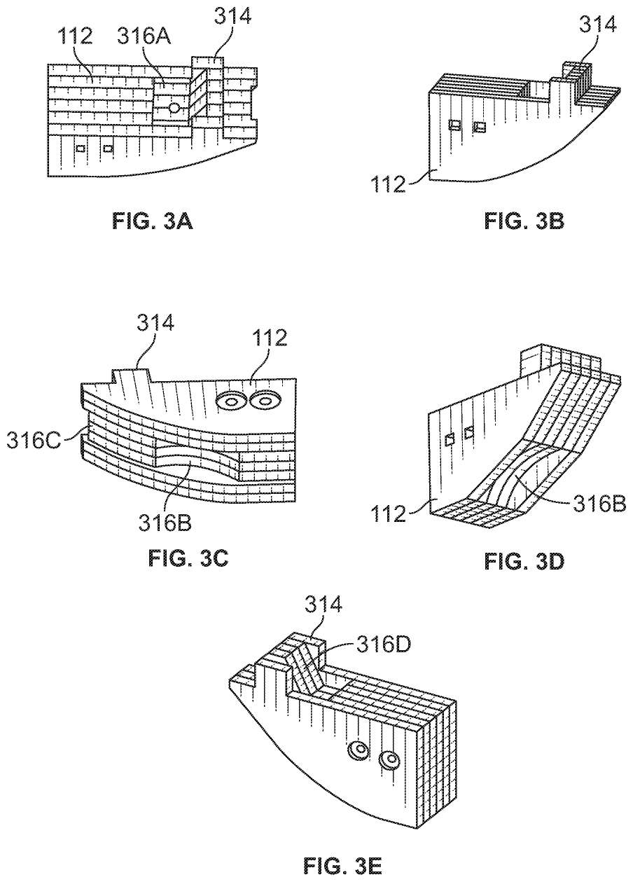

In yet another preferred embodiment, the rockers may be configured to quickly attach without the need for tools. Small slots on the sides of the custom backboard will allow the rockers to be strapped to backboard 120 and secured in place. For this embodiment, as shown in FIGS. 1C, 1E, 1F and 3A-3E the attachment of a pair of rockers 111 and 112, with an emphasis on rocker 112, will be discussed but the same methodology applies to other rockers as well. As shown, rocker 112 includes rectangular post 314 that is sized to fit within rectangular opening 310. This configuration of the openings may be used along the perimeter of backboard 120. Configuring opening 310 and post 314 to be rectangular prevents rocker 112 from rotating within opening 310 when post 314 is inserted.

Channels or notches 316A-316D are in communication with each other to form a recessed channel in rocker 112. This configuration may be used with the other rockers as well. By doing so, as shown in FIGS. 1C and 1F strap 312 may be wound around a pair of rockers (rockers 111 and 112 are depicted as examples) and through and around the corresponding openings in which the rockers are seated. Strap 312 may then be tightened to create a force that secures the rockers in place. Recessed channels 316A-316D provide a continuous channel that extends through the middle of a rocker and along the curved surface of a rocker to provide a pathway for strap 312. This further provides a track which secures the strap in place and in position during tightening and locates the strap a space distance away from a surface upon which the apparatus rests thereby preventing abrasion of the strap.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A patient lifting apparatus designed to facilitate the lifting of a patient off a surface comprising: a backboard having a perimeter, a patient receiving surface and an opposingly located lower surface having opposingly located bases thereon, each of said bases having opposingly located curved sections and a flat middle section located in between said curved sections.

2. The patient lifting apparatus of claim 1 wherein each of said bases is comprised of a pair of spaced-apart rockers, each of said rockers having a curved section that transitions into a flat section and said pair of rockers are spaced apart to form said flat middle section of said base.

3. The patient lifting apparatus of claim 2 wherein said backboard has a plurality openings around said perimeter.

4. The patient lifting apparatus of claim 4 wherein said openings are rectangular openings.

5. The patient lifting apparatus of claim 4 wherein each of said rockers include a rectangular post that fits within said rectangular openings and are locked in place thereby preventing said rectangular posts from rotating within said rectangular openings.

6. The patient lifting apparatus of claim 5 wherein said rockers include a channel that runs internally and around said curved surface, said channel adapted to receive a strap.

7. The patient lifting apparatus of claim 6 wherein said strap binds said rockers to said backboard.

8. The patient lifting apparatus of claim 7 wherein the apparatus is adapted to lift patients to 14″ off the ground.

9. The patient lifting apparatus of claim 8 further including a lifting mechanism.

10. The patient lifting apparatus of claim 9 wherein said lifting mechanism is a scissors.

11. The patient lifting apparatus of claim 9 wherein said lifting mechanism is an inflatable bladder.

12. The patient lifting apparatus of claim 9 wherein said lifting mechanism is a hydraulic lifting mechanism.

13. The patient lifting apparatus of claim 9 wherein said lifting mechanism is a screw system.

14. The patient lifting apparatus of claim 9 wherein said lifting mechanism is a pulley system.

15. A method for lifting a patient off of a surface comprising the following steps:
providing a backboard having a perimeter, a patient receiving surface and an opposingly located lower surface having opposingly located bases thereon, each of said bases having opposingly located curved sections and a flat middle section located in between said curved sections;
positioning a portion of said perimeter in near proximity to said patient and an opposing portion of said perimeter away from said patient;
raising said portion of said perimeter located away from said patient causing said portion of said perimeter near said patient to rotate downwardly toward said patient while said backboard is supported on said bases and rotates on said curved portion of said bases;
positioning said patient against said backboard; and
pushing downwardly on said perimeter causing said backboard to rotate on said curved edges lifting a patient upwardly until coming into an at-rest position on said flat middle sections of said bases.

16. The method for lifting a patient off of a surface of claim 15 further comprising the step of placing a lifting mechanism under said backboard and using said lifting mechanism to lift said backboard upwardly.

17. A method for lifting a patient off of a surface comprising the following steps:
providing a backboard having a perimeter, a patient receiving surface and an opposingly located lower surface; releasably securing a first and second base to said lower section of said backboard, each of said bases having opposingly located curved sections and a flat middle section located in between said curved sections;
positioning a portion of said perimeter in near proximity to said patient and an opposing portion of said perimeter away from said patient;
raising said portion of said perimeter located away from said patient causing said portion of said perimeter near said patient to rotate downwardly toward said patient while said backboard is supported on said bases and rotates on said curved portion of said bases;
positioning said patient against said backboard; and
pushing downwardly on said perimeter causing said backboard to rotate on said curved edges lifting a patient upwardly until coming into an at-rest position on said flat middle sections of said bases.

18. The patient lifting method of claim 17 wherein each of said bases is comprised of a pair of spaced-apart rockers, each of said rockers having a curved section that transitions into a flat section, said pair of rockers are spaced apart to form said flat middle section of said base and further including a strap that secures said rockers to said backboard.

19. The patient lifting method of claim 18 wherein said backboard has a plurality of rectangular openings and said rockers include a rectangular post that are inserted into said rectangular openings to prevent said rectangular posts from rotating within said rectangular openings, said rockers include a channel that runs internally and around said curved surface, said channel adapted to receive said strap.

20. The patient lifting method of claim 19 further comprising the step of placing a lifting mechanism under said backboard and using said lifting mechanism to lift said backboard upwardly.
